(19) United States
(12) Patent Application Publication
(10) Pub. No.: US 2006/0155623 A1
(43) Pub. Date: Jul. 13, 2006

(54) Agronomy bonus system and method

(76) Inventor: Mark A. Kistenmacher, Marshalltown, IA (US)

Correspondence Address: CHAPMAN AND CUTLER, 111 WEST MONROE STREET, CHICAGO, IL, 60603, US

(21) Appl. No.: 11/034,465

(22) Filed: Jan. 13, 2005

(51) Int. Cl. G06Q 40/00

(52) U.S. Cl. 705/35

(57) ABSTRACT

A method and system for encouraging farmers to sell at least portions of their production through an agricultural cooperative entity, wherein a farmer earns price discounts and/or rebates for purchases from the entity of inputs to his or her production upon sale of such production. The farmer contracts to sale such production either at or above a set price on a fixed date by way of selling a Chicago Board of Trade or a Minneapolis Grain Exchange call option or a swap in the Over The Counter Market or, if that price is not achieved, to sale within a year of his or her contract at a price of his or her choosing. The rebate or discount, as a portion of the call option or swap premium received, is then made available to the farmer for purchasing any of selected inputs available through the entity.

### FIELD OF THE INVENTION

The present invention relates to systems and methods for promoting and maintaining farmer member loyalty in an agricultural cooperative, using call options in the commodities futures market such as the Chicago Board of Trade or the Minneapolis Grain Exchange or swaps in the Over The Counter Market to fund rebates or discounts for farmer purchases of agricultural inputs from the cooperative.

### BACKGROUND OF THE ART

Many purchase reward systems are known at the consumer level, such as “green stamps” that may be given with purchases as at grocery stores, secured into stamp books, and then redeemed for merchandise or cash when the books are filled. Such programs as well as airline mileage clubs, affinity and cash-back credit cards, and the like build loyalty to an organization or a business by providing rebates, discounts, or donations to others from time to time after purchases are made. These programs cost the providers money directly for funding the rewards given.

No system is known where rebates or discounts are provided and funded by selling on a commodities exchange call options or swaps tied to a spot or futures market. That is, a premium received from selling a call option or swap funds a rebate or discount to the producer who sells his or her agriculture products though a cooperative enterprise, and the rebate or discount is for purchase of agricultural inputs such as seed, fertilizer, nitrogen, weed control chemicals, fuel and agronomy services.

### SUMMARY OF THE INVENTION

It is an object of this invention to encourage farmers and like producers to sell their agricultural products through a local or regional cooperative by offering rebates or discounts on purchases of agricultural inputs from that cooperative to those who agree to sell through the cooperative at least portions of their annual or seasonal production of specified crops. It is a further object to provide such encouragement without risk to the cooperative, by employing the sale of call options or swaps on a commodity exchange to fund the producer rebate or discount program.

In accordance with the invention, farmers and like producers who are members of an agricultural production cooperative are offered rebates or discounts on their purchases of agricultural inputs, such as seed, fertilizer, nitrogen, weed control chemicals, fuel, and agronomy services, from the cooperative in amounts determined by their commitment to deliver part or all of their agricultural production to the cooperative for sale. The cooperative then sells on a commodities exchange, such as the Chicago Board of Trade and Grain Exchange, call options or swaps in the Over The Counter Market on the agriculture products in an appropriate futures market; the cooperative then shares the premium received from the sale of the call option or swap with the producers by way of the rebates or discounts offered. If the market price for a commodity exceeds the agreed contract set price on a set day for future delivery then the sale is completed in accordance with the terms and conditions of the contract. If not, then the farmer can set his price and/or delivery date for any time within the following year, subject to determination at a date certain as specified in the terms and conditions of the contract. Once the sale is completed, at the set price or otherwise, then the rebate or discount is made available to the farmer.

### THE PREFERRED EMBODIMENTS

Farmers often have joined together in local or regional “cooperatives” to jointly administer the tasks of storing, marketing, selling, and delivering their farm products in the world market, thereby obtaining some economies of scale. These cooperative ventures operate on non-profit bases, with annual net savings being allocated back to the farmer members based on their member business. Cooperatives are not exclusive in any locale or region, however, and must compete for participating member farmers as any other business organization does, based on their business savvy and demonstrated successes in best fulfilling the needs of their members.

While participation incentives and bonuses are known in other endeavors, as airline mileage clubs for frequent fliers, credit card rebates for consumers, “green stamps”, and the like, none is known at the farm production and distribution level of commerce. This level has unique problems and conditions to which typical incentive, rebate, and discount programs have not been adapted, although some similarities may be seen.

In accordance with the principles of the present invention, a cooperative entity encourages farmer member participation in its crop sales program by providing a specified range of “agronomy bonus” options to its members who agree to provide some or all of their agricultural products for sale through the cooperative during a specific time period. The bonus preferably takes the form of a discount on future purchases from the cooperative of agricultural inputs such as seed, fertilizer, nitrogen, weed control chemicals, fuel, and agronomy services, or it may be provided as a rebate on past purchases. In either event the participating farmers will have increased loyalty to the cooperative that offers the plan, improving the stature of the cooperative and its market position as its resources are thus increased.

In accordance with principles, steps or method, and system of the invention, from time to time the cooperative determines how many bushels of each product, as corn or soybeans, its members will submit to or though it for sale in the commodities markets. It then for example, sells call options in a commodities futures market, such as the Chicago Board of Trade or Minneapolis Grain Exchange, or it sells swaps in the Over The Counter Market in this amount of bushels contracted in order to fund the rebate or discount plan for its farmer members. Sale of a Board of Trade call option on a 5,000 bushel lot of corn, for instance, at a set date, say Sep. 15, 2005, for December 2005 delivery, at $2.60 per bushel, nets an immediate return of, say, 12 cents per bushel or $600 per lot when the option is sold. That Chicago Board of Trade call option requires delivery of the 5,000 bushels at the appointed time and place, but only if the option is exercised by or on the set date by the buyer. Normally of course the option would be exercised if, but only if, the closing market price at the set date for the future delivery is at or above the set price (Chicago Board of Trade $2.60) provided in the call option. If the market price for the future delivery at the set date were lower than the set price (Chicago Board of Trade $2.60), then the Chicago Board of Trade call option would not be exercised but would expire without value. The farmer or cooperative would then keep both the corn, for separate future sale and delivery, and the prior call or swap funding payment received.

In one example of the application and use of the invention, a cooperative offers to its farmer members that it will provide its sellers an agronomy bonus of $100 per ton for Anhydrous Ammonia (NH-3) purchased for and applied to corn acreage for up to 20%, for instance, of a farmer's total planned corn acreage. The bonus may alternatively be allowed as a discount of $20 per ton of NH-3 for all such product purchased and applied to the total corn acreage. Application rates would be specified, such as 200 pounds of NH-3 per acre of corn. Such farmer-sellers would agree by contract to provide, through the cooperative for sale, the corn to be harvested from 20% of their total corn acreage, for instance, under the bonus contract. Bushel yields would be specified, such as 170 bushels per acre of corn. Participating farmers and the cooperative would further agree for instance that if the Chicago Board of Trade corn future price for December 2005 on a certain date, as Sep. 15, 2005, closes at or above the set price of, for example, $2.60 per bushel, then the corn is sold and to be delivered at the appointed time, under the contract terms and conditions, with payment at $2.60 per bushel, less a basis charge, to be made by the cooperative to the farmer.

If the closing price on the set date is less than the contracted set price, then the corn is not sold by the farmer or cooperative but the cooperative retains the right to take delivery of the grain from the participating farmer, and the farmer's obligation to deliver continues for up to a year from the original contract date. The price and delivery date within that time are subject to market fluctuations; if the corn is not sold by the anniversary then the farmer or cooperative will sell the corn at a then-current price, as for instance on a spot market. The farmer then would deliver it within a short time thereafter if not already in the cooperative's elevator, and the cooperative would then remit the net proceeds to the farmer-seller. The agronomy bonus would be available for use from the time of actual sale and delivery of the corn and for up to a year afterwards, but would expire if not used within that time. The farmer then would designate the product input to be purchased with the bonus, and that product would be delivered and/or applied by the cooperative at an agreed time and to an agreed area of the farm fields.

Alternative agronomy bonus options for participating farmers may comprise, for instance, a $37.24 per gallon discount on Round-up® Weathermax® brand weed control formulation for application to 20% of the farmer's soybean acres, at 22 oz. per acre, or a $7.45 per gallon discount applied to all the soybean acres. Another alternative is a discount for purchases of 28% nitrogen fertilizer, or other discounts. Portions of the call option payments not remitted to the participating farmers are retained by the cooperative for the added costs of managing the program, subject to distribution back to the members of all excess in cooperative's annual net income.

Another example for computing an agronomy bonus in accordance with the invention is for a farmer with 4,800 corn acres and 3,200 soybean acres who commits 20% of his or her production to the program. At agreed bonus rates of $10 per participating acre of corn and $6.40 per participating acre for soybeans, the total bonus is $9,600 for the corn plus $4,096 for the soybeans, allowing a credit of $13,696 for participation in the cooperative's sales program. Then 96 tons of ammonia (NH-3), normally retailing for $405 per ton, for application at 200 pounds per acre, would have a discount of $9,600 through the bonus program and cost the farmer only $29,280, or $305 per ton—a 25% discount—for the 20% of the corn acres committed to the program. Alternatively for the corn, the farmer could choose to apply the corn bonus to acquiring 28% nitrogen fertilizer, for application at 583 pounds per acre; 280 tons of 28% nitrogen normally retailing for about $200 per ton, would cost only $46,368 after the discount, or $165.69 per ton. The farmer also, for the soybeans committed through the cooperative, could acquire a weed killer, as Roundup® Weathermax One Trip®, for 20% of his or her soybeans, 110 gallons for application at 22 oz per acre, normally retailing for $47 per gallon, for under $10 per gallon, an 80% discount, for the 640 submitted acres.

Rebates for past season agronomy production inputs already purchased, or discounts on future season's agronomy inputs, may alternatively be offered to farmers.

Many variations may be made in the invention as described and its manner of use, without departing from the principles of the invention as described herein and/or as claimed below as the invention. Minor variations will not avoid the use of the invention.

I claim as my invention:

1. A method of encouraging agricultural producers to sell a product through a farming cooperative, the method comprising the steps:
offering to the producers rebates or discounts on their purchases of at least one input to their production, conditioned on the producers' submitting at least a portion of their production for delivery and sale through the cooperative by a future date certain;
selling on a commodities exchange call options or swaps for the right to purchase said portion of the producers production for delivery on or before said future date certain at a set price; and
providing a stated dollars per unit rebate or discount on at least one input to the production for one of the current and a future season's production of said product.

2. The method of claim 1, wherein the product is at least one of corn, soybeans, wheat, oats, cotton, rice, canola, and sugar cane.

3. The method of claim 1, wherein the inputs are at least one of seed, fertilizer, nitrogen, weed control chemicals, fuel, and agronomy services.

4. The method of claim 1, wherein a rebate is offered for an input purchased for the current production season.

5. The method of claim 1, wherein a rebate or discount is given for an input purchased for a following production season.

6. The method of claim 1, wherein the commodities exchange provides call options or swaps as a futures market.

7. The method of claim 1, wherein the commodities exchange is a spot market, for current delivery.

8. A method of providing mutual economic benefit to an agricultural cooperative entity and to farmer-members of such entity, the method encouraging farmers to sell their farm products through the entity by providing discounts or rebates to the farmers on needed farm inputs purchased through the cooperative, conditioned on sale through the entity of at least portions of a farmer's total production, the method comprising the steps:
inviting a farmer-member to sell at least a stated portion of his or her seasonal production of a product through the cooperative for delivery by a date certain;
offering a discount or a rebate on purchases of production inputs by the farmer from the cooperative, conditioned on sale of the product by the delivery date through the cooperative;
selling call options or swaps for purchase of said portion of the producer's production through a commodities market for a set price and for delivery at a future date;
consummating a sale of the product either through exercise of the option or swap or at a lesser price and different delivery date;
reporting to the farmer the price obtained, deductions made, and rebate or discount earned; and
selling the farmer at least one said input with said rebate or discount earned from the sale of the option or swap to buy the farmer's product.

9. The method of claim 8, wherein the stated portion is production from at least about 20% of the total acreage available to the farmer for the product, at a stated average yield per acre.

10. The method of claim 8, wherein the agricultural production inputs comprise one of seed, fertilizer, nitrogen, weed control chemicals, fuel and agronomy services.

11. The method of claim 8, wherein the discount earned is for future purchases of production inputs, after the discount is earned by fulfilling of all conditions.

12. The method of claim 8, wherein the rebate is given for past purchases of production inputs, paid after the rebate is earned by fulfilling of all conditions.

13. The method of claim 8, wherein the commodities market is a futures market.

14. The method of claim 8, wherein the commodities market is a spot market.

15. The method of claim 8, wherein at least one of the inviting, offering, and reporting steps is done on and through an electronic communications system comprising at least one of a telephone modem and a worldwide computer network.

16. A system for maximizing financial returns to both a farmer and an agricultural cooperative entity, the system comprising:
a written contract between the farmer and the entity providing for sale of at least a stated portion of the farmer's production through the entity and for a discount or rebate to the farmer for inputs purchased from the entity upon occurrence of certain conditions;
an arrangement for sale and delivery of the farmer's production portion through the entity and through a commodities market of the entity's choosing, using a call option or swap for future delivery at a time certain, for exercise on or by a date certain and at a set price, with remittance to the entity;
a discount or rebate mechanism for granting the farmer a lesser price for or rebates on inputs used to produce either the products sold or similar products produced in a later season; and
a payment system for transmitting the purchase money, less commissions and deductions, by or at the direction of the entity, to the farmer or to his or her account.

17. The system of claim 16, wherein the stated portion is at least 20% of the estimated production from all of the farmer's producing acreage for a given product.

18. The system of claim 17, wherein the production is estimated for a given crop at an historic or average rate of production per acre for the farmer or the locale of the farmer.
